(19) United States
(12) Patent Application Publication
(10) Pub. No.: US 2026/0278929 A1
(43) Pub. Date: Sep. 17, 2026

(54) METHOD AND DEVICE FOR GENERATING LIGHT DETECTION AND RANGING POINT CLOUD MAP OF LARGE-SCALE OUTDOOR SCENE

(71) Applicant: Wuhan University, Wuhan (CN)

(72) Inventors: Zhi Gao, Wuhan (CN); Zhiyu Zhou, Wuhan (CN)

(21) Appl. No.: 19/331,197

(22) Filed: Sep. 17, 2025

(30) Foreign Application Priority Data
Mar. 14, 2025 (CN) 202510301880.4

(51) Int. Cl. G06T 17/05; G06T 5/70; G06T 7/11; G06T 7/187

(52) U.S. Cl. CPC G06T 17/05; G06T 5/70; G06T 7/11; G06T 7/187; G06T 2207/10028; G06T 2207/20076; G06T 2207/20192; G06T 2215/16

(57) ABSTRACT

A method for generating LiDAR point cloud map of an outdoor scene includes steps as follows. An initial segmentation result of a target LiDAR point cloud map is obtained based on a region growing segmentation approach, and boundary point optimization is performed on the initial segmentation result to acquire a target planar segmentation result of the target LiDAR point cloud map. Target normal vectors of segmented planes in the target planar segmentation result are calculated, and planar point cloud refinement is performed on the target planar segmentation result to generate a refined point cloud map. Planar segmentation is performed on the refined point cloud map to obtain a new target planar segmentation result, target wall corner structures of the new target planar segmentation result are determined, and noise points from wall corner points in the target wall corner structures are removed to generate a refined outdoor LiDAR point cloud map.

### CROSS-REFERENCE TO RELATED APPLICATION

This application claims priority to Chinese Patent Application No. 202510301880.4, filed on Mar. 14, 2025, which is herein incorporated by reference in its entirety.

### TECHNICAL FIELD

The disclosure relates to the technical field of point cloud data processing, and particularly to a method and device for generating light detection and ranging (LiDAR) point cloud map of a large-scale outdoor scene.

### BACKGROUND

LiDAR is a high precision active sensor that is widely used in three-dimensional reconstruction tasks. However, limitations in the LiDAR system design and errors in the reconstruction algorithms often introduce heavy data noise into the resulting three-dimensional point cloud map. This problem is most visible in a large-scale outdoor scene, where building facades show excessive thickness.

Since the LiDAR point cloud map is a key input for generating three-dimensional structural models, and because point cloud accuracy cannot be improved quickly through hardware or algorithmic upgrades, the increased data noise prevents the map from meeting the requirements of complex scenes. Improvement is urgently needed.

### SUMMARY

The disclosure provides a method and device for generating LiDAR point cloud map of a large-scale outdoor scene to solve the problem in the related art that, because the LiDAR point cloud map serves as a critical input for generating three dimensional structural models and point cloud accuracy cannot be improved in a short time through hardware or algorithmic upgrades, data noise is increased and requirements for generating point cloud maps under complex scenes cannot be met.

A method for generating LiDAR point cloud map of a large-scale outdoor scene is provided, which includes steps as follows.

An initial segmentation result of a target LiDAR point cloud map is obtained based on a region growing segmentation approach, and boundary point optimization is performed on the initial segmentation result to acquire a target planar segmentation result of the target LiDAR point cloud map. Target normal vectors of all segmented planes in the target planar segmentation result are calculated, and planar point cloud refinement is performed on the target planar segmentation result by using the target normal vectors to generate a refined point cloud map. Planar segmentation is performed on the refined point cloud map to obtain a new target planar segmentation result, target wall corner structures of the new target planar segmentation result are determined, and noise points from wall corner points in the target wall corner structures are removed to generate a refined outdoor LiDAR point cloud map.

In an embodiment, the obtaining, based on a region growing segmentation approach, an initial segmentation result of a target LiDAR point cloud map includes steps as follows. A local normal vector of each scan point in the target LiDAR point cloud map is calculated. Point cloud clustering is performed on the local normal vector of each scan point based on the region growing segmentation approach to obtain the initial segmentation result of the target LiDAR point cloud map.

In an embodiment, the performing boundary point optimization on the initial segmentation result includes steps as follows. Perpendicular distances and Euclidean distances from each of non-planar points to the segmented planes, and target non-planar points satisfying a preset condition of the non-planar points are determined based on the perpendicular distances and the Euclidean distances. The target non-planar points satisfying the preset condition are assigned into the segmented planes, thereby performing the boundary point optimization on the initial segmentation result.

In an embodiment, the performing, using the target normal vectors, planar point cloud refinement on the target planar segmentation result to generate a refined point cloud map includes steps as follows. A neighborhood centroid of planar points in the segmented planes is calculated. New planar points in the segmented planes are determined based on the planar points, the neighborhood centroid, and the target normal vectors. The refined point cloud map is generated based on the new planar points.

In an embodiment, the determining target wall corner structures of the new target planar segmentation result, and removing target noise points from wall corner points in the target wall corner structures to generate a refined outdoor LiDAR point cloud map includes steps as follows. Target planes in the new target planar segmentation result are acquired, whether each of the target planes is one of the target wall corner structures is determined. In response to each of the target planes being the one of the target wall corner structures, the target noise points from the wall corner points are removed to generate the refined outdoor LiDAR point cloud map.

A device for generating LiDAR point cloud map of a large-scale outdoor scene is provided, which includes an acquisition module, a processing module, and a generation module. The acquisition module is configured to obtain, based on a region growing segmentation approach, an initial segmentation result of a target LiDAR point cloud map and perform boundary point optimization on the initial segmentation result to acquire a target planar segmentation result of the target LiDAR point cloud map. The processing module is configured to calculate target normal vectors of all segmented planes in the target planar segmentation result, and perform, using the target normal vectors, planar point cloud refinement on the target planar segmentation result to generate a refined point cloud map. The generation module is configured to perform planar segmentation on the refined point cloud map to obtain a new target planar segmentation result, determine target wall corner structures of the new target planar segmentation result, and remove noise points from wall corner points in the target wall corner structures to generate a refined outdoor LiDAR point cloud map.

In an embodiment, the acquisition module includes a first computation unit and a first acquisition unit. The computation unit is configured to calculate a local normal vector of each scan point in the target LiDAR point cloud map. The acquisition unit is configured to perform point cloud clustering on the local normal vector of each scan point based on the region growing segmentation approach to obtain the initial segmentation result of the target LiDAR point cloud map.

In an embodiment, the acquisition module includes a second computation unit and a processing unit. The second computation unit is configured to calculate perpendicular distances and Euclidean distances from each of non-planar points to the segmented planes, and determine, based on the perpendicular distances and the Euclidean distances, target non-planar points satisfying a preset condition of the non-planar points. The processing unit is configured to assign the target non-planar points satisfying the preset condition into the segmented planes, thereby performing the boundary point optimization on the initial segmentation result.

In an embodiment, the processing module includes a third computation unit, a determining unit and a first generation unit. The third computation unit is configured to calculate a neighborhood centroid of planar points in the segmented planes. The determining unit is configured to determine new planar points in the segmented planes based on the planar points, the neighborhood centroid, and the target normal vectors. The first generation unit is configured to generate the refined point cloud map based on the new planar points.

In an embodiment, the generation module includes a second acquisition unit, a judgment unit and a second generation unit. The second acquisition unit is configured to acquire target planes in the new target planar segmentation result. The judgment unit is configured to determine whether each of the target planes is one of the target wall corner structures. The second generation unit is configured to, in response to each of the target planes being the one of the target wall corner structures, remove the target noise points from the wall corner points to generate the refined outdoor LiDAR point cloud map.

In an embodiment, the refined outdoor LiDAR point cloud map is superposed on a geographic information system map to obtain a superposed geographic information system map, and the superposed geographic information system map is displayed to a user interface of electronic devices, such as a mobile phone and an electronic screen, thereby to show the superposed geographic information system map to a user.

In an embodiment, each of the acquisition module, the processing module, the generation module, the first computation unit, the first acquisition unit, the second computation unit, the processing unit, the third computation unit, the determining unit, the first generation unit, the second acquisition unit, the judgment unit, and the second generation unit is embodied by at least one processor and at least one memory coupled to the at least one processor, and the at least one memory is stored with the method for generating LiDAR point cloud map of a large-scale outdoor scene executable by the at least one processor.

In an embodiment, an electronic device includes a memory, a processor, and a computer program stored on the memory and executable on the processor, the processor is configured to execute the computer program to implement the method for generating LiDAR point cloud map of the outdoor scene mentioned above.

In an embodiment, computer-readable storage medium is stored with a computer program, the computer program is configured, when being executed by a processor, to implement the method for generating LiDAR point cloud map of the outdoor scene mentioned above.

In an embodiment, a computer program product includes a computer program, the computer program, when executed by a processor, is configured to implement the method for generating LiDAR point cloud map of the outdoor scene mentioned above.

The embodiments of the disclosure, based on a region growing segmentation approach, can obtain an initial segmentation result of the target LiDAR point cloud map and perform boundary point optimization on the initial segmentation result to acquire a target planar segmentation result of the point cloud map; compute target normal vectors of all segmented planes within the target planar segmentation result and then perform planar point cloud refinement on the planar segmentation result; perform planar segmentation on the refined point cloud map, determine target wall corner structures of the new target planar segmentation result, and remove target outliers from wall corner points within the wall corner structures to generate a refined outdoor large scale LiDAR point cloud map, thereby effectively reducing data noise and satisfying the requirements for generating point cloud maps under complex scenes. Consequently, the problem in the related art is solved: point cloud accuracy cannot be improved in a short time through hardware or algorithmic upgrades, data noise is increased, and the requirements for generating point cloud maps under complex scenes cannot be met.

In an embodiment, after generating the refined outdoor LiDAR point cloud map, the refined outdoor LiDAR point cloud map is imported into a professional urban planning analysis platform (such as geographic information system, i.e., GIS or city information modeling, i.e., CIM). Semantic information is assigned to each point through automated algorithms (e.g., distinguishing buildings, ground, vegetation, streetlights, and other features), thereby transforming massive scattered points into a classifiable, queryable, and measurable urban feature object library. Subsequently, based on three-dimensional database of the professional urban planning analysis platform, spatial operations are directly performed on the real urban model: accurately calculating a floor area ratio and building density of a target region, simulating an impact of new projects on surrounding sunlight and wind environments, analyzing visual corridors in key areas, and seamlessly integrating future planning and design schemes into the existing scene for comparison and compatibility assessment. enabling automatic monitoring of illegal construction and urban changes through regular updates and comparative analysis.

Additional aspects and advantages of the disclosure will be set forth in part in the description which follows, and in part will be apparent from the description, or may be learned by practice of the disclosure.

### BRIEF DESCRIPTION OF DRAWINGS

The above and/or additional aspects and advantages of the disclosure will become apparent and easily understandable from the following description of embodiments, in conjunction with the attached drawings

FIG. 1 illustrates a flowchart of a method for generating LiDAR point cloud map of a large-scale outdoor scene according to an embodiment of the disclosure.

FIG. 2 illustrates a schematic principal diagram of the method for generating LiDAR point cloud map of the large-scale outdoor scene according to a specific embodiment of the disclosure.

FIG. 3 illustrates a schematic diagram of an initial segmentation result based on a region growing segmentation approach according to a specific embodiment of the disclosure.

FIG. 4 illustrates a schematic diagram of a target planar segmentation result based on the region growing segmentation approach and boundary point optimization according to a specific embodiment of the disclosure.

FIG. 5 illustrates a schematic structural diagram of a device for generating the LiDAR point cloud map of the large-scale outdoor scene according to an embodiment of the disclosure.

FIG. 6 illustrates schematic structural diagram of an electronic device according to the specific embodiment of the disclosure.

### DETAILED DESCRIPTION OF EMBODIMENTS

The following will describe embodiments of the disclosure in detail, with examples of the embodiments shown in the attached drawings, where the same or similar reference numerals throughout indicate the same or similar elements or elements having the same or similar functions. The embodiments described below with reference to the attached drawings are exemplary and are intended to explain the disclosure, and should not be construed as limiting the disclosure.

A method and device for generating LiDAR point cloud map of a large-scale outdoor scene according to embodiments of the disclosure are described below with reference to the attached drawings. Addressing the problem mentioned in the above related art, namely, that in related art point cloud accuracy cannot be improved in a short time through hardware or algorithmic upgrades, data noise is increased, and the requirements for generating point cloud maps under complex scenes cannot be met, the disclosure provides a method for generating LiDAR point cloud map of a large-scale outdoor scene. In this method, based on a region growing segmentation approach, an initial segmentation result of a target LiDAR point cloud map is obtained and boundary point optimization is performed on the initial segmentation result to acquire a target planar segmentation result of the point cloud map. Target normal vectors of all segmented planes within the target planar segmentation result are calculated, and planar point cloud refinement is then performed on the planar segmentation result. Planar segmentation is performed on the refined point cloud map, target wall corner structures of the new target planar segmentation result are determined, and noise points are removed from wall corner points within the wall corner structures to generate a refined large scale outdoor LiDAR point cloud map, thereby effectively reducing data noise and satisfying the demand for generating point cloud maps under complex scenes. Consequently, the problem in the related art is solved: point cloud accuracy cannot be improved in a short time through hardware or algorithmic upgrades, data noise is increased, and the requirements for generating point cloud maps under complex scenes cannot be met.

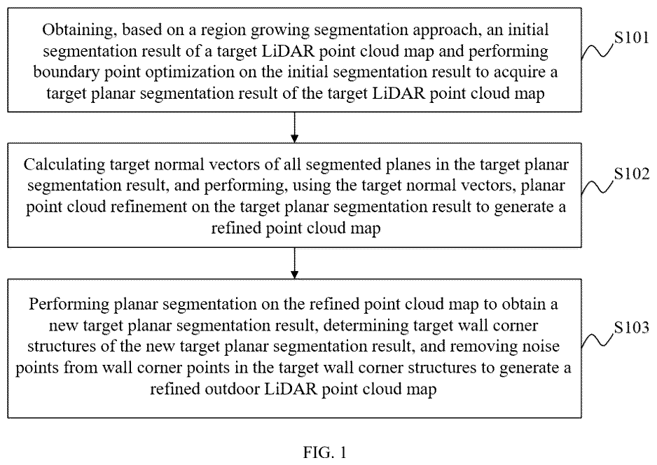

Specifically, FIG. 1 illustrates a flowchart of a method for generating LiDAR point cloud map of a large-scale outdoor scene according to an embodiment of the disclosure.

As shown in FIG. 1, the method for generating LiDAR point cloud map of the large-scale outdoor scene includes steps S101 to S103.

In the step S101, an initial segmentation result of a target LiDAR point cloud map is obtained based on a region growing segmentation approach, and boundary point optimization is performed on the initial segmentation result to acquire a target planar segmentation result of the target LiDAR point cloud map.

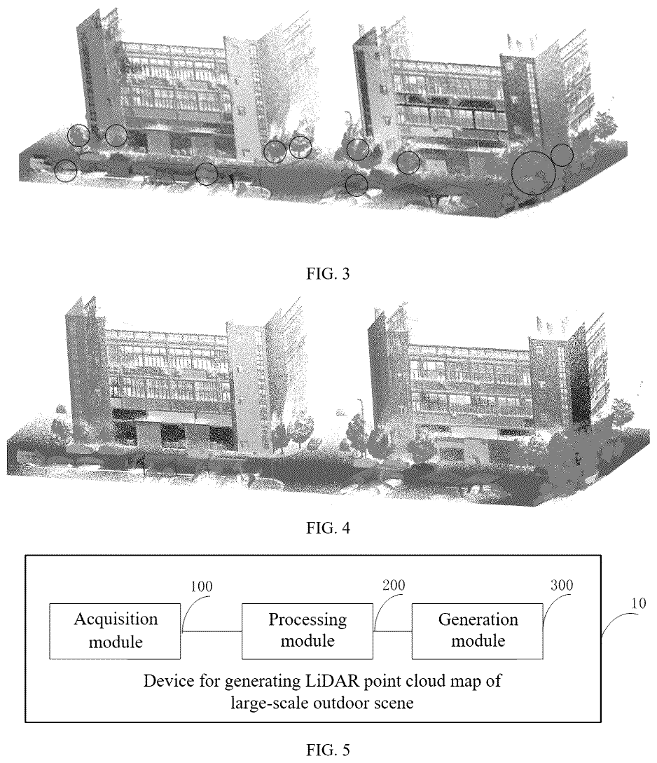

It can be understood that, based on the region growing segmentation approach, in the embodiment of the disclosure, the initial segmentation result of a target LiDAR point cloud map is obtained. For example, as shown in FIG. 3, circles contain non-planar scan points (Only a part of the non-planar scan points is illustrated). The embodiment adopts a parallel-computation strategy to compute a local normal vector of each scan point in the point cloud map and then apply the region-growing-based point cloud clustering method to cluster the scan points with similar local normal vectors, thereby obtaining the initial segmentation result of the large-scale outdoor LiDAR point cloud map. Subsequently, boundary point optimization is performed on the initial segmentation result: by calculating the perpendicular distance and the Euclidean distance from non-planar points to the segmented planes, certain non-planar points, such as point clouds at wall corners, are assigned into the segmented planes, so that the target planar segmentation result of the point cloud map is obtained, effectively improving feasibility of generating a refined large-scale outdoor LiDAR point cloud map.

In an embodiment, the obtaining, based on a region growing segmentation approach, an initial segmentation result of a target LiDAR point cloud map includes steps as follows. A local normal vector of each scan point in the target LiDAR point cloud map is calculated. Point cloud clustering is performed on the local normal vector of each scan point based on the region growing segmentation approach to obtain the initial segmentation result of the target LiDAR point cloud map.

During actual execution, in the embodiment of the disclosure, the local normal vector for each scan point in the LiDAR point cloud map is first calculated according to a formula expressed as follows:

$${n}^{*} = {arg min}_{n , ‖ n ‖ = 1} {\sum }_{i = 1}^{m} {( ( {x}_{i} - x ) n )}^{2}$$

where X represents a current scan point, xᵢ represents an i-th neighboring scan point of neighborhood points of the current scan point, m represents a total number of the neighborhood points (commonly set to 50), and n represents the local normal vector of each scan point to be solved.

Next, the local normal vector of each scan point is used as input to perform region growing (region growing segmentation approach) based point cloud clustering, which is implemented with the RegionGrowing class from the point cloud library (PCL) using the following parameter settings:

$$\{ \begin{matrix}Neighbours = 50 \\ Smoothness = 2.5 \\ Curvature = 0.18\end{matrix}$$

Consequently, the planar segmentation result based on region growing illustrated in FIG. 3 is obtained, non-planar point clouds at wall corners are correctly assigned into the corresponding segmented planes, effectively improving computational efficiency, segmentation accuracy and quality while reducing noise influence.

In an embodiment, the performing boundary point optimization on the initial segmentation result includes steps as follows. Perpendicular distances and Euclidean distances from non-planar points to the segmented planes are calculated and target non-planar points satisfying a preset condition of the non-planar points are determined based on the perpendicular distances and the Euclidean distances. The target non-planar points satisfying the preset condition are assigned into the segmented planes, thereby performing the boundary point optimization processing on the initial segmentation result.

As a possible implementation, in the embodiments of the disclosure, the scan points at wall corners that have not been assigned to any plane are processed. For each non-planar scan point xₙₚ, the perpendicular distance to every other segmented plane

$${\{ {P}_{i} \}}_{i}^{M}$$

is calculated with the following formula:

$${d}_{i}^{v} = ( 1 / ‖ n ‖ ) \vert {n}_{i} \cdot ( {x}_{n p} - ( 1 / m ) {\sum }_{k = 1}^{m} {p}_{k} ) \vert$$

where m represents the total number of the neighborhood points,

$${d}_{i}^{v}$$

represents the perpendicular distance from the non-planar scan point xₙₚ to the corresponding segmented plane Pᵢ, and n represents the local normal vector of the each scan point to be solved. And
the perpendicular distances are sorted, the ten segmented planes with the smallest perpendicular distances are retained for subsequent processing.

For the ten segmented planes

$${\{ {G}_{i} \}}_{i}^{10}$$

with the smallest perpendicular distances, the Euclidean distance from the non-planar scan point xₙₚ to each of the ten segmented planes is calculated as follows:

$${{d}_{i}^{e} = {min}_{k = 1}^{m} {‖}_{{X}_{np}} - {g}_{k} ‖}_{2}$$

where xₙₚ represents the non-planar scan point,

$${d}_{i}^{e}$$

represents the Euclidean distance from the non-planar scan point xₙₚ to a plane Gᵢ among the ten segmented planes, and gₖ represents a planar point of the plane Gᵢ.

The non-planar scan point xₙₚ is assigned to one of the ten segmented plane corresponding to the smallest the Euclidean distance

$${d}_{i}^{e} ,$$

thereby obtaining an updated segmented plane

$${\{ {P}_{i} \}}_{i}^{M} .$$

FIG. 4 illustrates the planar segmentation result after boundary point optimization. Consequently, embodiments of the disclosure perform boundary point optimization on the initial segmentation result to acquire the target planar segmentation result of the point cloud map, significantly improving the segmentation accuracy and quality of the point cloud map.

In the step S102, Target normal vectors of all segmented planes in the target planar segmentation result are calculated, and planar point cloud refinement is performed on the target planar segmentation result by using the target normal vectors to generate a refined point cloud map.

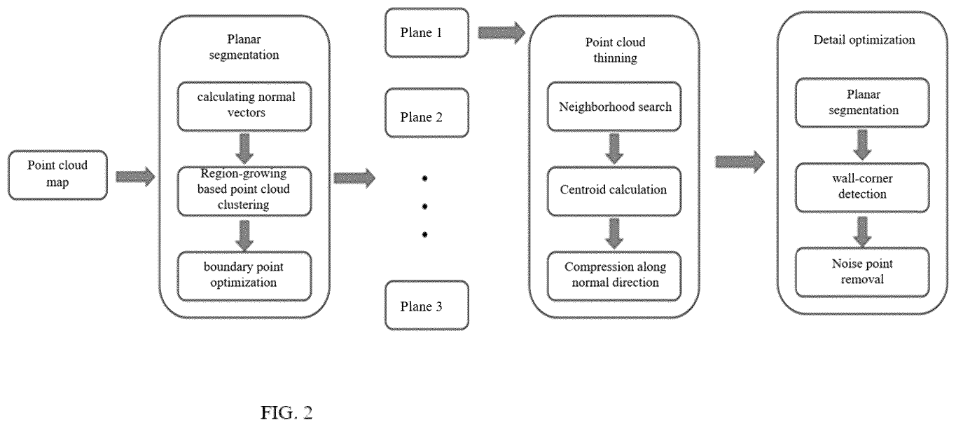

It can be understood that, in embodiments of the disclosure, target normal vectors of all segmented planes within the target planar segmentation result are calculated and then planar point cloud refinement is performed on the planar segmentation result by using the target normal vectors. For example, as shown in FIG. 2, the embodiments perform neighborhood searching for every planar point of a segmented plane, calculate the neighborhood centroid, and compress each planar point toward the neighborhood centroid along the plane normal, thereby thinning the plane and generating a refined point cloud map that effectively reduces data noise.

In an embodiment, the performing, using the target normal vectors, planar point cloud refinement on the target planar segmentation result to generate a refined point cloud map includes steps as follows. A neighborhood centroid of planar points in the segmented planes is calculated. New planar points in the segmented planes are determined based on the planar points, the neighborhood centroid, and the target normal vectors. The refined point cloud map is generated based on the new planar points.

In some embodiments, the planar point cloud refinement is performed on the updated segmented plane

$${\{ {P}_{i} \}}_{i}^{M}$$

obtained in the preceding steps. For the segmented plane Pᵢ, the neighborhood centroid meanₖ of its planar points pₖ is first calculated as follows:

$${mean}_{k} = ( 1 / n ) {\sum }_{i = 1}^{n} {p}_{i}$$

where n is set to 150.

Next, the normal vector normalᵢ of the segmented plane Pᵢ is calculated using principal component analysis, and the planar points pₖ are updated as follows:

$${p}_{k}^{′} = {p}_{k} + ( ( {mean}_{k} - {p}_{k} ) \cdot {normal}_{i} ) {normal}_{i}$$

where meanₖ represents the neighborhood centroid of the planar points pₖ, and normalᵢ represents the normal vector of the segmented plane Pᵢ.

After performing the above operations on the planar points of the all segmented planes, the planar point cloud refinement based on local normal vectors is completed.

In the steps S103, planar segmentation is performed on the refined point cloud map to obtain a new target planar segmentation result, target wall corner structures of the new target planar segmentation result are determined, and noise points from wall corner points in the target wall corner structures are removed to generate a refined outdoor LiDAR point cloud map.

It can be understood that, in the embodiments of the disclosure, the planar segmentation is performed on the refined point cloud map to obtain a new target planar segmentation result and target wall corner structures of the new target planar segmentation result are determined. For example, as shown in FIG. 2, by means of detail optimizing based on building structure regularization, the refined point cloud map is first subjected again to the planar segmentation steps described above, thereby obtaining a new target planar segmentation result. Next, the wall corner structures are identified through orthogonal checking and Euclidean distance evaluation. Finally, noise points within the wall corner points are identified and removed, thereby generating a refined large-scale outdoor LiDAR point cloud map, significantly improving the accuracy of device fusion mapping, reducing data noise, and satisfying the demand for generating refined point cloud maps in large-scale outdoor scenes.

In an embodiment, the determining target wall corner structures of the new target planar segmentation result, and removing target noise points from wall corner points in the target wall corner structures to generate a refined outdoor LiDAR point cloud map includes steps as follows. Target planes in the new target planar segmentation result are acquired, whether each of the target planes is one of the target wall corner structures is determined. In response to the each of the target planes being the one of the target wall corner structures, the noise points from the wall corner points are removed to generate the refined outdoor LiDAR point cloud map.

In some embodiments, first, the planar segmentation is again performed on the point cloud map that has undergone planar point cloud refinement based on region growing and boundary point optimization to obtain a new planar segmentation result

$${\{ {P}_{i} \}}_{i}^{M}$$

(i.e., new target planar segmentation result). Then, for all segmented planes in the new planar segmentation result

$${\{ {P}_{i} \}}_{i}^{M} ,$$

two segmented planes of all segmented planes are sequentially extracted and it is determined, based on orthogonality and Euclidean distance, whether the two segmented planes constitute a wall corner structure. For each plane pair Pⱼ, every plane within

$${\{ {P}_{i} \}}_{i}^{M}$$

is traversed, and an orthogonality between Pⱼ and Pₖ (Two arbitrary planes obtained through traversal) is calculated as follows:

$${o}_{j , k} = {normal}_{j} \cdot {normal}_{k}$$

normalⱼ, normalₖ are normal vectors of Pⱼ and Pₖ.

The orthogonality values o_{j,k} of each the two segmented planes are sorted, and the five plane pairs with the smallest orthogonality values o_{j,k} are selected as candidate planes

$${\{ {G}_{i} \}}_{i}^{5} .$$

The Euclidean distance between every plane and each candidate plane is then calculated as follows:

$${d}_{{G}_{i}}^{e} = {{min}_{j = 1}^{n}}_{k = 1}^{m} {‖ {p}_{j} - {g}_{k} ‖}_{2}$$

where

$${d}_{{G}_{i}}^{e}$$

represents the Euclidean distance between a plane Pⱼ and corresponding one candidate plane Gᵢ of the candidate planes

$${\{ {G}_{i} \}}_{i}^{5} ,$$

pⱼ represents a planar point of the plane Pⱼ, n represents a number of planar points, gₖ represents a planar point of the corresponding one candidate plane Gᵢ, and m represents a number of planar points.

If the orthogonality o_{j,i} between the candidate plane Gᵢ that has the smallest

$${d}_{{G}_{i}}^{e}$$

and the plane P₃ is less than a given threshold orthogonal (here set to 0.17), then Gᵢ and Pⱼ are considered to form a wall corner structure.

For each identified wall corner plane pair (Pⱼ and Gₖ), building structure regularization is first applied. Each plane of the pair is processed individually. For one of the planes Pⱼ, its planar points

$${\{ {p}_{i} \}}_{i = 1}^{n}$$

are classified into a positive point set positive and a negative point set negative according to the following rule:

$$if ( {p}_{i} - {center}_{k} ) \cdot {normal}_{k} > 0 {p}_{i} \to positive$$

$$if ( {p}_{i} - {center}_{k} ) \cdot {normal}_{k} < 0 {p}_{i} \to negative$$

where centerₖ represents a centroid of the plane Gₖ.

First, a point set with the larger number of points between the positive point set positive and the negative point set negative is processed. Assuming the positive point set positive contains more points, every point in the positive point set positive is updated according to the following rule:

$$if ( {ps}_{i} - {center}_{k} ) \cdot {normal}_{k} ∈ ( 0 , proximity ) {ps}_{i}^{′} = {ps}_{i} - movedist \times {normal}_{k}$$

$$if ( {ps}_{i} - {center}_{k} ) \cdot {normal}_{k} ∈ ( - proximity , 0 ) {ps}_{i}^{′} = {ps}_{i} + movedist \times {normal}_{k}$$

where psᵢ represents a point in the positive point set positive; proximity represents a distance threshold for determining how close a point must be to the other plane, here set to 0.2 m; and movedist represents a distance by which a point in the positive point set positive is moved toward the other plane, here set to 0.1 m.

After the above operations have been completed for both planes of the wall corner plane pair, noise points are removed as the final step. The updated plane pair

$${P}_{j}^{′} and {G}_{k}^{′}$$

are processed separately. For each plane

$${P}_{j}^{′} ,$$

its planar points p are again classified into a positive point set positive and a negative point set negative according to the following rule:

$$if ( {p}_{i}^{′} - {center}_{k} ) \cdot {normal}_{k} > 0 {p}_{i}^{′} \to {positive}^{′}$$

$$if ( {p}_{i}^{′} - {center}_{k} ) \cdot {normal}_{k} < 0 {p}_{i}^{′} \to {negative}^{′}$$

Here, the point set with the smaller number of points, assumed to be negative point set negative, is treated as a noise point set, and points in negative point set negative are removed from the point cloud map, thereby completing the detail optimizing operation based on building structure regularization.

According to the method for generating LiDAR point cloud map of the large-scale outdoor scene provided by embodiments of the disclosure, an initial segmentation result of a target LiDAR point cloud map is obtained based on a region growing segmentation approach, and boundary point optimization is performed on the initial segmentation result to acquire a target planar segmentation result of the point cloud map; target normal vectors of all segmented planes within the target planar segmentation result are computed, and planar point cloud refinement is performed on the planar segmentation result; planar segmentation is carried out on the refined point cloud map, target wall corner structures of the new target planar segmentation result are determined, and target outliers are removed from wall corner points within the wall corner structures to generate a refined outdoor large scale LiDAR point cloud map, thereby effectively reducing data noise and satisfying the demand for generating point cloud maps under complex scenes. Consequently, the problem in the related art is solved: point cloud accuracy cannot be improved in a short time through hardware or algorithmic upgrades, data noise is increased, and the requirements for generating point cloud maps under complex scenes cannot be met.

In an embodiment, a device for generating LiDAR point cloud map of the large-scale outdoor scene will be described with reference to the attached drawings.

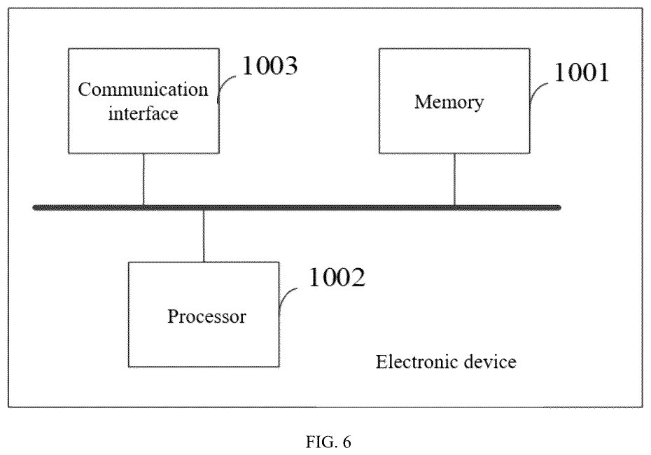

FIG. 5 illustrates a schematic structural diagram of the device for generating the LiDAR point cloud map of the large-scale outdoor scene according to an embodiment of the disclosure.

Specifically, a device 10 for generating LiDAR point cloud map of a large-scale outdoor scene is provided, which includes an acquisition module 100, a processing module 200, and a generation module 300.

The acquisition module 100 is configured to obtain, based on a region growing segmentation approach, an initial segmentation result of a target LiDAR point cloud map and perform boundary point optimization on the initial segmentation result to acquire a target planar segmentation result of the target LiDAR point cloud map.

The processing module 200 is configured to calculate target normal vectors of all segmented planes in the target planar segmentation result, and perform, using the target normal vectors, planar point cloud refinement on the target planar segmentation result to generate a refined point cloud map.

The generation module 300 is configured to perform planar segmentation on the refined point cloud map to obtain a new target planar segmentation result, determine target wall corner structures of the new target planar segmentation result, and remove noise points from wall corner points in the target wall corner structures to generate a refined outdoor LiDAR point cloud map.

In an embodiment, the acquisition module 100 includes a first computation unit and a first acquisition unit. The computation unit is configured to calculate a local normal vector of each scan point in the target LiDAR point cloud map. The acquisition unit is configured to perform point cloud clustering on the local normal vector of each scan point based on the region growing segmentation approach to obtain the initial segmentation result of the target LiDAR point cloud map.

In an embodiment, the acquisition module 100 includes a second computation unit and a processing unit. The second computation unit is configured to calculate perpendicular distances and Euclidean distances from each of non-planar points to the segmented planes, and determine, based on the perpendicular distances and the Euclidean distances, target non-planar points satisfying a preset condition of the non-planar points. The processing unit is configured to assign the non-planar points satisfying the preset condition into the segmented planes, thereby performing the boundary point optimization on the initial segmentation result.

In an embodiment, the processing module 200 includes a third computation unit, a determining unit and a first generation unit. The third computation unit is configured to calculate a neighborhood centroid of planar points in the segmented planes. The determining unit is configured to determine new planar points in the segmented planes based on the planar points, the neighborhood centroid, and the target normal vectors. The first generation unit is configured to generate the refined point cloud map based on the new planar points.

In an embodiment, the generation module 300 includes a second acquisition unit, a judgment unit and a second generation unit. The second acquisition unit is configured to acquire target planes in the new target planar segmentation result. The judgment unit is configured to determine whether each of the target planes is one of the target wall corner structures. The second generation unit is configured to, in response to the each of the target planes being the one of the target wall corner structures, remove the target noise points from the wall corner points to generate the refined outdoor LiDAR point cloud map.

It should be noted that the explanations of the embodiments of the method for generating LiDAR point cloud map of the large-scale outdoor scene also apply to the embodiments of the device for generating LiDAR point cloud map of the large-scale outdoor scene, and will not be repeated here.

According to the device for generating LiDAR point cloud map of the large-scale outdoor scene provided by embodiments of the disclosure, an initial segmentation result of a target LiDAR point cloud map is obtained based on a region growing segmentation approach, and boundary point optimization is performed on the initial segmentation result to acquire a target planar segmentation result of the point cloud map; target normal vectors of all segmented planes within the target planar segmentation result are computed, and planar point cloud refinement is performed on the planar segmentation result; planar segmentation is then carried out on the refined point cloud map, target wall corner structures of the new target planar segmentation result are determined, and target outliers are removed from wall corner points within the wall corner structures to generate a refined outdoor large scale LiDAR point cloud map, thereby effectively reducing data noise and satisfying the demand for generating point cloud maps under complex scenes. Consequently, the problem in the related art is solved: point cloud accuracy cannot be improved in a short time through hardware or algorithmic upgrades, data noise is increased, and the requirements for generating point cloud maps under complex scenes cannot be met.

FIG. 6 illustrates schematic structural diagram of an electronic device according to the specific embodiment of the disclosure.

In an embodiment, an electronic device includes a memory 1001, a processor 1002, and a computer program stored on the memory and executable on the processor 1002, the processor 1002 is configured to execute the computer program to implement the method for generating LiDAR point cloud map of the outdoor scene mentioned above.

In an embodiment, the electronic device further includes a communication interface 1003 configured for communication between the memory 1001 and the processor 1002, the memory 1001 configured to store a computer program executable on the processor 1002, and the memory 1001 may include a high-speed random access memory (RAM) and may also include a non-volatile memory, for example at least one disk storage.

If the memory 1001, the processor 1002, and the communication interface 1003 are implemented independently, the communication interface 1003, the memory 1001, and the processor 1002 can be interconnected via a bus and complete mutual communication. The bus may be an industry standard architecture (ISA) bus, a peripheral component interconnect (PCI) bus, or an extended industry standard architecture (EISA) bus, etc. The bus can be divided into an address bus, a data bus, a control bus, and so on. For ease of illustration, only one thick line is shown in FIG. 6, but this does not indicate that there is only one bus or one type of bus.

In an embodiment, if the memory 1001, the processor 1002, and the communication interface 1003 are integrated onto a single chip, the memory 1001, the processor 1002, and the communication interface 1003 can complete mutual communication through an internal interface.

The processor 1002 may be a central processing unit (CPU), or an application specific integrated circuit (ASIC), or one or more integrated circuits configured to implement the embodiments of the disclosure.

In an embodiment, computer-readable storage medium is stored with a computer program, the computer program is configured, when being executed by a processor, to implement the method for generating LiDAR point cloud map of the outdoor scene mentioned above.

In an embodiment, a computer program product includes a computer program, the computer program, when executed by a processor, is configured to implement the method for generating LiDAR point cloud map of the outdoor scene mentioned above.

In the description of this specification, reference to the terms “an embodiment,” “some embodiments,” “example,” “specific example,” or “some examples,” etc., means that a specific feature, structure, material, or characteristic described in connection with the embodiment or example is included in at least one embodiment or example of the disclosure. In this specification, the schematic representations of the above terms do not necessarily refer to the same embodiment or example. Moreover, the specific features, structures, materials, or characteristics described may be combined in any suitable manner in any one or N embodiments or examples. In addition, without mutual contradiction, those skilled in the art can combine and integrate the different embodiments or examples described in this specification as well as the features of the different embodiments or examples.

In addition, the terms “first,” “second,” and the like are used solely for descriptive purposes and shall not be construed as indicating or implying relative importance or implicitly specifying the number of indicated technical features. Thus, features defined as “first” or “second” may explicitly or implicitly include at least one such feature. In the description of the disclosure, “N” means at least two, for example two, three, etc., unless explicitly and specifically stated otherwise.

Any process or method description in the flowcharts or otherwise described herein can be understood as representing a module, segment, or portion of code that comprises one or N steps of executable instructions for implementing customized logic functions or processes. The scope of the preferred embodiments of the disclosure also encompasses alternative implementations in which the functions may be executed in orders other than those shown or discussed, including in substantially simultaneous fashion or in reverse order according to the involved functionality, as will be understood by those skilled in the art to which the embodiments of the disclosure pertain.

Logic and/or steps represented in the flowcharts or otherwise described herein may be regarded as a sequenced list of executable instructions for implementing logical functions and may be embodied in any computer-readable medium for use by or in connection with an instruction execution system, apparatus, or device, such as a computer-based system, a processor-containing system, or any other system capable of fetching instructions from and executing instructions of the instruction execution system, apparatus, or device. For the purposes of this specification, a “computer-readable medium” can be any means that can contain, store, communicate, propagate, or transport the program for use by or in connection with the instruction execution system, apparatus, or device. More specific examples (a non-exhaustive list) of the computer-readable medium include the following: an electrical connection having one or N wires (electronic device), a portable computer diskette (magnetic device), a RAM, a read-only memory (ROM), an erasable programmable read-only memory (EPROM or flash memory), an optical fiber device, and a portable compact disc read-only memory (CDROM). In addition, the computer-readable medium can even be paper or another suitable medium upon which the program is printed, because the program can be electronically obtained by optically scanning the paper or other medium, followed by editing, interpretation, or any other suitable processing if necessary, and then stored in a computer memory.

It should be understood that each part of the disclosure may be implemented in hardware, software, firmware, or any combination thereof. In the above embodiments, N steps or methods may be implemented in software or firmware stored in memory and executed by a suitable instruction execution system. If implemented in hardware, and as in another embodiment, any one or a combination of the following techniques well known in the art may be employed: discrete logic circuits having logic gate circuits for performing logic functions upon data signals, application specific integrated circuits having suitable combinational logic gate circuits, programmable gate arrays (PGA), field programmable gate arrays (FPGA), and the like.

Those skilled in the art will understand that all or part of the steps carried in the above-described method embodiments may be performed by a program instructing relevant hardware, and such program may be stored in a computer-readable storage medium. When the program is executed, it includes one of the steps of the method embodiments or any combination thereof.

In addition, each functional unit in the various embodiments of the disclosure may be integrated into one processing module, or each unit may exist physically as an individual unit, or two or more units may be integrated into one module. The integrated module may be implemented in the form of hardware or in the form of a software functional module. When the integrated module is implemented as a software functional module and sold or used as an independent product, it may also be stored in a computer-readable storage medium.

The storage medium mentioned above may be a read-only memory, a magnetic disk, an optical disc, or the like. Although the embodiments of the disclosure have been shown and described above, it is to be understood that these embodiments are illustrative and shall not be construed as limiting the disclosure. Those skilled in the art may make variations, modifications, substitutions, and alterations to the above embodiments within the scope of the disclosure.

1. A method for generating light detection and ranging (LiDAR) point cloud map of a large-scale outdoor scene, comprising:
obtaining, based on a region growing segmentation approach, an initial segmentation result of a target LiDAR point cloud map, and performing boundary point optimization on the initial segmentation result to acquire a target planar segmentation result of the target LiDAR point cloud map; wherein the obtaining, based on a region growing segmentation approach, an initial segmentation result of a target LiDAR point cloud map comprises:
calculating a local normal vector of each scan point in the target LiDAR point cloud map; and
performing point cloud clustering on the local normal vector of each scan point based on the region growing segmentation approach to obtain the initial segmentation result of the target LiDAR point cloud map;
wherein the local normal vector of each scan point is calculated according to a formula expressed as follows:
$${n}^{*} = {arg min}_{n , ‖ n ‖ = 1} {\sum }_{i = 1}^{m} {( ( {x}_{i} - x ) n )}^{2}$$
where x represents a current scan point, xᵢ represents one of neighborhood points of the current scan point, m represents a total number of the neighborhood points, and n represents a local normal vector of each scan point to be solved;
calculating target normal vectors of all segmented planes in the target planar segmentation result, and performing, using the target normal vectors, planar point cloud refinement on the target planar segmentation result to generate a refined point cloud map; wherein the performing, using the target normal vectors, planar point cloud refinement on the target planar segmentation result to generate a refined point cloud map comprises:
calculating a neighborhood centroid of planar points in the segmented planes;
determining new planar points in the segmented planes based on the planar points, the neighborhood centroid, and the target normal vectors; and
generating the refined point cloud map based on the new planar points;
wherein the neighborhood centroid of the planar points in the segmented planes is calculated according to a formula expressed as follows:
$${mean}_{k} = ( 1 / n ) {\sum }_{i = 1}^{n} {p}_{i}$$
where n is set to 150, meanₖ represents the neighborhood centroid of the planar points pₖ, and pᵢ represents a segmented plane;
wherein the determining new planar points in the segmented planes based on the planar points, the neighborhood centroid, and the target normal vectors comprises:
calculating the target normal vector normalᵢ of the segmented plane pᵢ using principal component analysis and updating the planar points pₖ according to a formula expressed as follows:
$${p}_{k}^{′} = {p}_{k} + ( ( {mean}_{k} - {p}_{k} ) \cdot {normal}_{i} ) {normal}_{i}$$
where
$${p}_{k}^{′}$$
represents the new planar points, meanₖ represents the neighborhood centroid of the planar points pₖ, and normalᵢ represents the target normal vector of the segmented plane pᵢ; and
performing planar segmentation on the refined point cloud map to obtain a new target planar segmentation result, determining target wall corner structures of the new target planar segmentation result, and removing target noise points from wall corner points in the target wall corner structures to generate a refined LiDAR point cloud map of the large-scale outdoor scene.

2. The method for generating LiDAR point cloud map of the large-scale outdoor scene as claimed in claim 1, wherein the performing boundary point optimization on the initial segmentation result comprises:
calculating perpendicular distances and Euclidean distances from each of non-planar points to the segmented planes, and determining target non-planar points satisfying a preset condition of the non-planar points; and
assigning the target non-planar points satisfying the preset condition into the segmented planes, thereby performing the boundary point optimization on the initial segmentation result.

3. The method for generating LiDAR point cloud map of the large-scale outdoor scene as claimed in claim 1, wherein the determining target wall corner structures of the new target planar segmentation result, and removing target noise points from wall corner points in the target wall corner structures to generate a refined LiDAR point cloud map of the large-scale outdoor scene comprises:
acquiring target planes in the new target planar segmentation result;
determining whether each of the target planes is one of the target wall corner structures; and
in response to each of the target planes being the one of the target wall corner structures, removing the target noise points from the wall corner points to generate the refined LiDAR point cloud map of the large-scale outdoor scene.

4. A device for generating LiDAR point cloud map of a large-scale outdoor scene, comprising:
an acquisition module, configured to obtain, based on a region growing segmentation approach, an initial segmentation result of a target LiDAR point cloud map and perform boundary point optimization on the initial segmentation result to acquire a target planar segmentation result of the target LiDAR point cloud map; wherein acquisition module configured to obtain, based on a region growing segmentation approach, an initial segmentation result of a target LiDAR point cloud map comprises to:
calculate a local normal vector of each scan point in the target LiDAR point cloud map; and
perform point cloud clustering on the local normal vector of each scan point based on the region growing segmentation approach to obtain the initial segmentation result of the target LiDAR point cloud map;
wherein the local normal vector of each scan point is calculated according to a formula expressed as follows:
$${n}^{*} = {arg min}_{n , ‖ n ‖ = 1} {\sum }_{i = 1}^{m} {( ( {x}_{i} - x ) n )}^{2}$$
where x represents a current scan point, xᵢ represents one of neighborhood points of the current scan point, m represents a total number of the neighborhood points, and n represents a local normal vector of each scan point to be solved;
a processing module, configured to calculate target normal vectors of all segmented planes in the target planar segmentation result, and perform, using the target normal vectors, planar point cloud refinement on the target planar segmentation result to generate a refined point cloud map; wherein the processing module configured to perform, using the target normal vectors, planar point cloud refinement on the target planar segmentation result to generate a refined point cloud map comprises to:
calculate a neighborhood centroid of planar points in the segmented planes;
determine new planar points in the segmented planes based on the planar points, the neighborhood centroid, and the target normal vectors; and
generate the refined point cloud map based on the new planar points;
wherein the neighborhood centroid of the planar points in the segmented planes is calculated according to a formula expressed as follows:
$${mean}_{k} = ( 1 / n ) {\sum }_{i = 1}^{n} {p}_{i}$$
where n is set to 150, meanₖ represents the neighborhood centroid of the planar points pₖ, and pᵢ represents the segmented planes;
wherein the determining new planar points in the segmented planes based on the planar points, the neighborhood centroid, and the target normal vectors is configured to:
calculate the target normal vectors normalᵢ of the segmented planes pᵢ using principal component analysis and updating the planar points pₖ according to a formula expressed as follows:
$${p}_{k}^{′} = {p}_{k} + ( ( {mean}_{k} - {p}_{k} ) \cdot {normal}_{i} ) {normal}_{i}$$
where
$${p}_{k}^{′}$$
represents the new planar points, meanₖ represents the neighborhood centroid of the planar points pₖ, and normalᵢ represents the target normal vector of the segmented plane pᵢ; and
a generation module, configured to perform planar segmentation on the refined point cloud map to obtain a new target planar segmentation result, determine target wall corner structures of the new target planar segmentation result, and remove target noise points from wall corner points in the target wall corner structures to generate a refined LiDAR point cloud map of the large-scale outdoor scene.

5. An electronic device, comprising: a memory, a processor, and a computer program stored on the memory and executable on the processor, the processor is configured to execute the computer program to implement the method for generating LiDAR point cloud map of the large-scale outdoor scene as claimed in claim 1.

6. A computer-readable storage medium stored with a computer program, wherein the computer program is configured, when being executed by a processor, to implement the method for generating LiDAR point cloud map of the large-scale outdoor scene as claimed in claim 1.

7. A computer program product comprising a computer program, wherein the computer program, when executed by a processor, is configured to implement the method for generating LiDAR point cloud map of the large-scale outdoor scene as claimed in claim 1.
